(19) United States
(12) Patent Application Publication
(10) Pub. No.: US 2009/0016912 A1
(43) Pub. Date: Jan. 15, 2009

(54) Internal Gear Fuel Pump

(75) Inventor: Holger Barth, Friedewald (DE)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: SIEMENS AKTIENGESELLSCHAFT, Munchen (DE)

(21) Appl. No.: 11/913,606

(22) PCT Filed: May 3, 2006
(86) PCT No.: PCT/EP06/61997

§ 371 Date: Nov. 5, 2007

(30) Foreign Application Priority Data
May 10, 2005 (DE) 10 2005 021 597.1

(51) Int. Cl. F04B 35/04; B23P 17/00

(52) U.S. Cl. 417/410.1; 29/888

(57) ABSTRACT

A fuel pump has a housing (6), an electric motor (1) arranged in the housing (6) and is provided with a stator (7) and a rotor (8) having a shaft (9). The shaft (9) extends to the area of a pump stage (2) and passes therethrough. The pump stage (2) is configured as a G-rotor stage. The shaft (9) of the electric motor (1) has, on its periphery, at least two flattened portions (16, 17) at least in the area (10) in which the shaft (9) passes through an inner rotor (15) of the G-rotor stage (2), whilst the inner rotor (15) of the rotor stage (2) has an identically configured recess (18).

### CROSS-REFERENCE TO RELATED APPLICATIONS

This application is a U.S. national stage application of International Application No. PCT/EP2006/061997 filed May 3, 2006, which designates the United States of America, and claims priority to German application number 10 2005 021 597.1 filed May 10, 2005, the contents of which are hereby incorporated by reference in their entirety.

### TECHNICAL FIELD

The invention relates to a fuel pump with a casing and with an electric motor arranged in the casing and consisting of a stator and of a rotor having a shaft, the shaft extending into the region of a pumping stage and penetrating the latter.

### BACKGROUND

Such fuel pumps are used in feed units which are employed in fuel tanks of motor vehicles in order to convey fuel out of the fuel tank to an internal combustion engine of the motor vehicle.

Fuel pumps of this type have long been the state of the art and are therefore known. Positive displacement pumps, in particular G-rotor pumps have proved appropriate as pumping stages of these fuel pumps. The positive displacement pumps employed as G-rotor pumps consist of an inner rotor and of an outer rotor, the inner rotor being driven by the electric motor. On account of the pressures generated by a G-rotor pump, high forces occur in a G-rotor pump. The inner rotor is therefore connected to the electric motor via a coupling. The coupling is arranged on the shaft of the electric motor and possesses a plurality of drivers which are oriented in the direction of the inner rotor and parallel to the shaft and engage into recesses of the inner rotor. The inner rotor is set in rotation by these drivers. This coupling may either be a separate component or be a part of the plastic injection-molded around the rotor. In the latter instance, the coupling is produced in one piece with the rotor. The disadvantage of this is that the coupling is in the form of a plastic component. On account of the forces occurring when the G-rotor pump is in operation, a coupling consisting of plastic must have a relatively large number of drivers, in order reliably to avoid damage to the coupling as a result of the forces occurring during operation. However, even if the coupling is produced as a separate component from metal with a smaller number of drivers, there is the disadvantage that an additional component is present which has to be produced and mounted.

### SUMMARY

According to an embodiment, a fuel pump of the type initially mentioned, which is especially cost-effective and, in particular, dispenses with additional components or components having a complicated configuration, may have a casing and an electric motor arranged in the casing, wherein the motor comprises a stator and a rotor having a shaft, the shaft extending into and penetrating the region of a pumping stage, wherein the pumping stage is designed as a G-rotor stage, the shaft of the electric motor has at least two flattenings on its circumference at least in the region in which the shaft penetrates an inner rotor of the G-rotor stage and wherein the inner rotor of the G-rotor stage has a likewise configured recess.

According to another embodiment, the flattenings may be oriented in the region opposite one another and parallel to one another on the circumference of the shaft. According to another embodiment, the shaft may possess three flattenings in its region. According to another embodiment, the shaft can be designed in cross section as a polygon in its region. According to another embodiment, the shaft can be designed in its region as a splined shaft.

### BRIEF DESCRIPTION OF THE DRAWINGS

The invention is explained in more detail with reference to three exemplary embodiments. In the drawing:

FIG. 1: shows a section through a fuel pump according to an embodiment,

FIG. 2 shows a secondary embodiment in a section A-A from FIG. 1, and

FIG. 3 shows a third embodiment in a section A-A from FIG. 1.

### DETAILED DESCRIPTION

According to an embodiment, the pumping stage is designed as a G-rotor stage, the shaft of the electric motor has at least two flattenings on its circumference at least in the region in which the shaft penetrates the inner rotor, and the inner rotor of the G-rotor stage has a likewise configured recess.

It was found, surprisingly, that, contrary to the prevailing opinion, there is no need for an additional coupling for connecting the electric motor to the inner rotor, and that the inner rotor can be driven directly by the shaft if the shaft in this case has at least two flattenings. In particular, the tilting moments generated on account of the pressure at the outlet port of the G-rotor stage are absorbed via the at least two flattenings with the result that a skewing of the inner rotor is effectively avoided. The essential advantage is that the coupling is dispensed with as an additional component. The fuel pump consequently has a simpler configuration, can be assembled more quickly and is therefore, overall, more cost-effective.

The two flattenings on the shaft can be produced especially simply if they are oriented opposite one another on the circumference of the shaft and consequently parallel to one another.

In a further refinement, the loads occurring in the G-rotor pump are counteracted when the shaft has three flattenings in the region with which it penetrates the inner rotor.

It became apparent that could be advantageous, in the case of higher forces and moments, to design the corresponding shaft portion as a polygon or splined shaft.

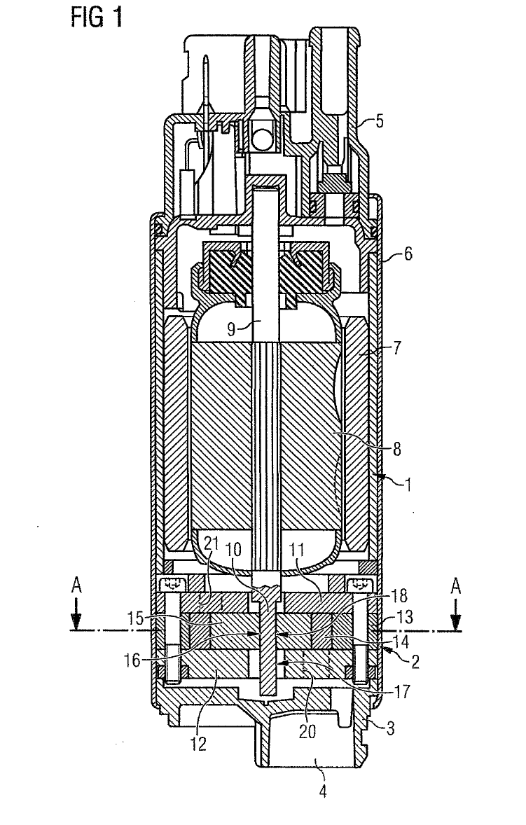

The fuel pump illustrated in FIG. 1 consists of an electric motor 1 and a pumping stage 2 designed as G-rotor pump. A cover 3 with a fuel inlet 4 is arranged on that side of the pumping stage 2 which faces away from the electric motor 1. On the opposite side of the fuel pump, a connection piece 5 closes off the fuel pump. The cover 3 and the connection piece 5 are connected to a common casing 5. The electric motor 1 possesses a rotor 8 arranged in a stator 7 and having a shaft 9. A region 10 of the shaft 9 penetrates the G-rotor pump 2. The G-rotor pump 2 consists of two casing plates 11, 12 which are arranged so as to be spaced apart from one another via a spacer ring 13. An outer rotor 14 and an inner rotor 15 are mounted rotatably between the two casing plates 11, 12. The shaft 9 possesses in the region 10, two flattenings 16, 17 which lie opposite one another and parallel to one another and which are arranged in a corresponding recess 18 of the inner rotor 15, so that, in the event of a rotation of the rotor 8 and consequently of the shaft 9, the inner rotor 15 is set in rotation. When the pumping stage 2 is in operation, the fuel is sucked in axially via the intake connection piece 4 and a port 20 in the casing plate 12 while it leaves the pumping stage 2 in the axial direction via the port 21.

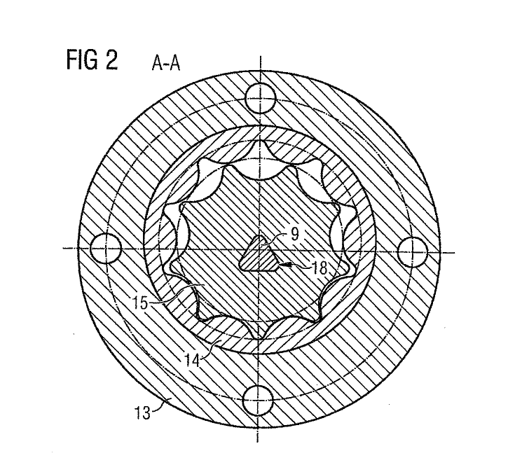

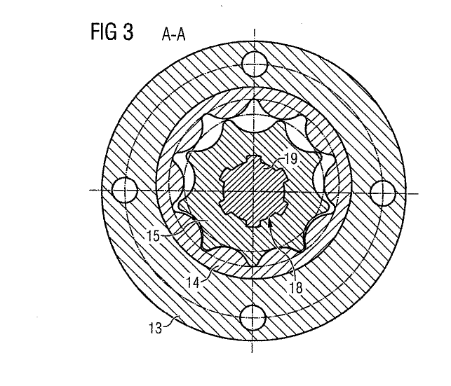

FIGS. 2 and 3 show in each case profiles of the shaft 9 in the region 10 which differ from FIG. 1. In FIG. 2, the shaft 9 possesses a polygonal profile. For this purpose, three flattenings 16 to 18 are present on the shaft 9, the flattenings 16-18 being designed in such a way that the shaft 9 possesses an approximately triangular cross section in this region. In FIG. 9, the shaft 9 is designed in the region 10 as a splined shaft 19 which engages into a correspondingly configured receptacle 18 of the inner rotor 15.

What is claimed is:

1. A fuel pump comprising: a casing and an electric motor arranged in the casing, wherein the motor comprises a stator and a rotor having a shaft, the shaft extending into and penetrating the region of a pumping stage, wherein the pumping stage is designed as a G-rotor stage, the shaft of the electric motor has at least two flattenings on its circumference at least in the region in which the shaft penetrates an inner rotor of the G-rotor stage and wherein the inner rotor of the G-rotor stage has a likewise configured recess.

2. The fuel pump according to claim 1, wherein the flattenings are oriented in the region opposite one another and parallel to one another on the circumference of the shaft.

3. The fuel pump according to claim 1, wherein the shaft possesses three flattenings in its region.

4. The fuel pump according to claim 1, wherein the shaft is designed in cross section as a polygon in its region.

5. The fuel pump according to claim 1, wherein the shaft is designed in its region as a splined shaft.

6. A fuel pump comprising: an electric motor arranged in a casing, wherein the motor comprises a stator and a rotor having a shaft, the shaft extending into and penetrating the region of a pumping stage, wherein the pumping stage is designed as a G-rotor stage, the shaft of the electric motor has at least two flattenings on its circumference at least in the region in which the shaft penetrates an inner rotor of the G-rotor stage, the inner rotor of the G-rotor stage has a likewise configured recess, and wherein the flattenings are oriented in the region opposite one another and parallel to one another on the circumference of the shaft.

7. The fuel pump according to claim 6, wherein the shaft possesses three flattenings in its region.

8. The fuel pump according to claim 6, wherein the shaft is designed in cross section as a polygon in its region.

9. The fuel pump according to claim 6, wherein the shaft is designed in its region as a splined shaft.

10. A method for manufacturing a fuel pump comprising the steps of:
arranging an electric motor in a casing, wherein the motor comprises a stator and a rotor having a shaft,
extending the shaft into a region of a pumping stage, wherein the shaft penetrates the pumping stage and wherein the pumping stage is designed as a G-rotor stage, the shaft of the electric motor having at least two flattenings on its circumference at least in the region in which the shaft penetrates an inner rotor of the G-rotor stage and wherein the inner rotor of the G-rotor stage has a likewise configured recess.

11. The method according to claim 10, comprising the step of orienting the flattenings in the region opposite one another and parallel to one another on the circumference of the shaft.

12. The method according to claim 10, wherein the shaft possesses three flattenings in its region.

13. The method according to claim 10, wherein the shaft is designed in cross section as a polygon in its region.

14. The method according to claim 10, wherein the shaft is designed in its region as a splined shaft.
